(19) United States
(12) Patent Application Publication
(10) Pub. No.: US 2024/0330760 A1
(43) Pub. Date: Oct. 3, 2024

(54) CENTRALLY COLLECTING AND TRACKING MODEL UPDATE INPUTS

(71) Applicant: Schlumberger Technology Corporation, Sugar Land, TX (US)

(72) Inventors: Daiye ZHENG, Kuala Lumpur (MY); Jason DRESSEL, Calgary (CA); Michael John BACK, Calgary (CA); Niranjan Madhukar KARVEKAR, Pune (IN); Anina MENDEZ, Kerala (IN); Yulia ANTONEVICH, Abingdon (GB); Prafulla Madhavrao KULKARNI, Pune (IN)

(21) Appl. No.: 18/251,085

(22) PCT Filed: Oct. 26, 2021
(86) PCT No.: PCT/US2021/056532

§ 371 Date: Apr. 28, 2023

Related U.S. Application Data
(60) Provisional application No. 63/198,621, filed on Oct. 30, 2020.

(51) Int. Cl. G06N 20/00

(52) U.S. Cl. CPC G06N 20/00

(57) ABSTRACT

Methods, computing systems, and computer-readable media for centrally collecting and tracking incorporation of model update inputs for developing and updating a model, of which one method includes receiving the model update inputs via a centralized system, sending a notification to one or more contributors associated with the model notifying that the model update inputs have been received, receiving information identifying progress of incorporation of the update inputs into the model, generating transaction records identifying the progress and actions taken to incorporate the update inputs into the model, and storing or outputting the transaction records.

### CROSS REFERENCE TO RELATED APPLICATIONS

The present application claims priority benefit of U.S. Provisional Application No. 63/198,621, filed Oct. 30, 2020, the entirety of which is incorporated by reference herein and should be considered part of this specification.

### BACKGROUND

Models may be developed to evaluate an asset (e.g., an oil/gas-related asset). The process for developing a model may involve manual collection of data and inputs from various domain contributors, and coordinating the incorporation of the inputs into model development. The data and inputs used to construct and/or update a model may originate from disparate sources and may involve a series of complex approving processes, workflows, and decisions.

### SUMMARY

Embodiments of the disclosure may provide a method for centrally collecting and tracking incorporation of model update inputs for developing and updating a model. The method includes receiving the model update inputs via a centralized system, sending a notification to one or more contributors associated with the model notifying that the model update inputs have been received, receiving information identifying progress of incorporation of the update inputs into the model, generating transaction records identifying the progress and actions taken to incorporate the update inputs into the model, and storing or outputting the transaction records.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example flowchart for centrally tracking model development inputs in accordance with aspects of the present disclosure.

FIG. 3 illustrates an example model that may be developed and updated over time using the techniques described herein.

FIG. 4 illustrates an example of roles for different project team members that may use the input centralization and tracking system to collaborate and report update input incorporate progress.

FIG. 5 illustrates an example process for integrating the roles of different contributors for incorporating model inputs to develop a model used to evaluate on an asset.

FIG. 6 illustrates another example process for integrating the roles of different contributors for incorporating model inputs to develop a model used to evaluate on an asset.

FIG. 7 illustrates a schematic view of a computing system, according to an embodiment.

### DETAILED DESCRIPTION

Model development and updating may involve a series of updates as new data and inputs become available by contributors, stakeholders, etc. Inputs used to update and develop models may be disparate and may originate from various locations, departments, organizations, databases, software tools, etc. Thus, collecting and incorporating inputs may be time consuming and error prone. Accordingly, aspects of the present disclosure may include a system and/or method to centralize the collection and incorporation of inputs used to construct and/or update a model (e.g., used for to evaluate the performance of an investment o asset, such as an oil/gas-related asset) as the model is being developed. In some embodiments, the system and/or method may store updates as “transactions” in which the transactions identify historical changes made to the model, contributors involved in the changed, change approval activity, etc. In this way, transactions may be used to track the evolution of the model as the model is updated over a period of time. Further, aspects of the present disclosure may centralize model inputs (e.g., in a cloud-based system) that may originate from disparate locations and team members across various geographic locations. In this way, the systems and/or methods, described herein, may streamline approval processes, workflows, and contributions made by different types of contributors who may perform different actions in their role in updating and developing a model.

Aspects of the present disclosure may provide a secured cloud-based framework to capture and centralize model inputs that emerge from different parts of an organization (e.g., business) over time to capture ideas from different contributors and improve collaboration in an accessible, consistent catalog, the improved flexibility. For example, aspects of the present disclosure may include an input centralization and tracking system that includes a secure and centralized cloud-based system to centralize the collection of model inputs and track incorporation of the model inputs as transactions and visualize the progression of incorporating model inputs and model update inputs. In some embodiments, the input centralization and tracking system may host a user interface to facilitate team collaboration on in incorporating model updates. As described herein, the input centralization and tracking system may host a communications and media platform to facilitate communications between team members in conjunction with the collection and incorporation of model update inputs (e.g., to expedite and facilitate approvals of updates, incorporation of updates, etc.).

The techniques described herein may assist organization planners in identifying a plan direction to pursue and which assets to develop in a balanced portfolio based on models that have been constructed and updated using the systems and/or methods described herein. Also, aspects of the present disclosure may improve the capability to quickly change focus or direction and update models accordingly as the market for products and operating environments change. Further, model data may be more easily categorized and transferred to other systems through consistent opportunity capture for data aggregation and comparison across assets, business units, and countries. Aspects of the present disclosure are not limited to construction, development, and/or updating a model by centralized input collection and tracking, but may also be used to construct, develop, and/or update a simulation, a workflow, and/or other entity in which update and development inputs and data may be disparate across different organizations, departments, locations, etc.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

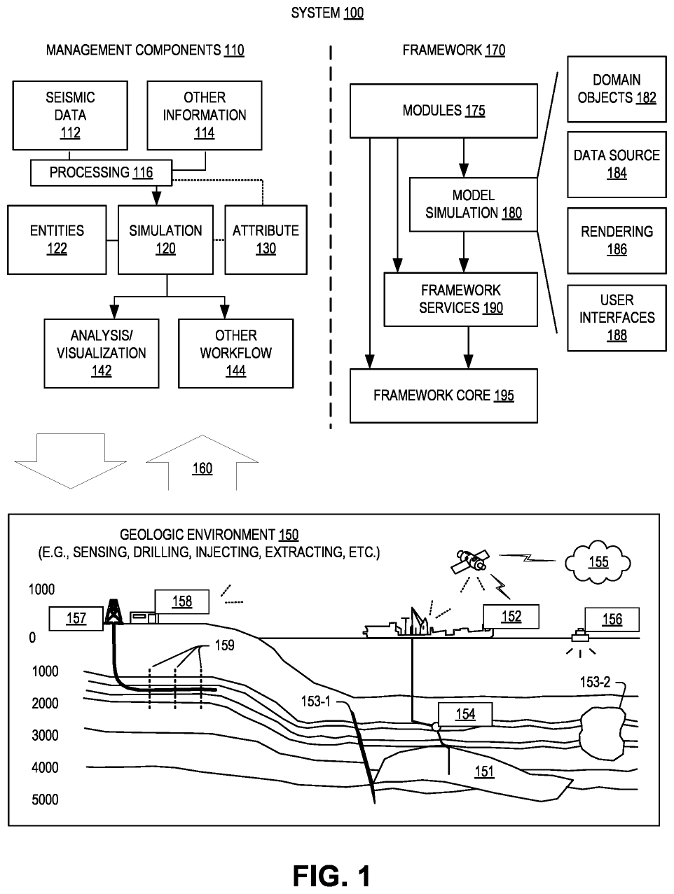

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

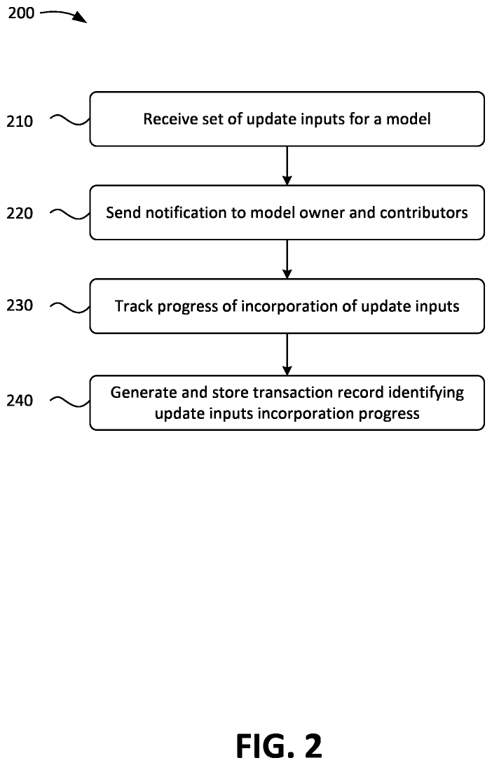

FIG. 2 illustrates an example flowchart for centrally tracking model development inputs in accordance with aspects of the present disclosure. The process 200 of FIG. 2 may be performed by a computing device, such as an input centralization and tracking system, which may be a centralized cloud-server accessible by client computing systems. As shown in FIG. 2, the process 200 may include receiving a set of update inputs for a model (as at block 210). For example, the input centralization and tracking system may receive a set of update inputs for updating a model. In some embodiments, the update inputs may be received from a contributor, a model owner, a stakeholder, etc. via a user interface hosted by a client computing system. In some embodiments, the update inputs may identify the model, the type of updates or changes being made to the model, and/or other information regarding the model and its changes. In some embodiments, the update inputs may identify the contributors and/or approvers that may be involved in incorporating the update inputs for updating and/or developing the model.

The process 200 also may include sending a notification to model owners and contributors (as at block 220). For example, the input centralization and tracking system may send a notification to model owners and contributors that update inputs to the model have been received by the input centralization and tracking system. Based on receiving the notification, the owners and/or contributors may incorporate the update inputs to the model to further update and develop the model. For example, any number of workflows or processes may be performed by different groups and organizations in conjunction with incorporating the model (e.g., change approval processes, software development and implementation processes, etc.). In some embodiments, the input centralization and tracking system may identify a “chain of custody” of the update inputs as the incorporation of update inputs progresses across team members.

The process 200 further may include tracking the progress of incorporation of the update inputs (as at block 230). For example, the input centralization and tracking system may receive information tracking the progress of incorporation of the update inputs. As described herein, the input centralization and tracking system may host a communications platform and a task tracking platform to facilitate communications between team members in conjunction with collecting and incorporating updates. In some embodiments, the input centralization and tracking system may receive user input via the communications and task tracking platform indicating the progress of incorporation of the update inputs (e.g., approval progress, implementation progress, etc.).

The process 200 also may include generating and storing transaction record identifying update inputs incorporation progress (as at block 240). For example, the input centralization and tracking system may generate a transaction record identifying a progress event. In some embodiments, a progress event may include a change made to the progress of incorporating the update inputs to the model. As an example, a transaction record may identify a progress event, such as an approval of the update inputs, a change to the update inputs, progress of a workflow to incorporate the update inputs, team member/contributor comments made in conjunction with the update inputs, etc. In some embodiments, the input centralization and tracking system may store the transaction record which may be accessed at a later time for analysis. As described herein, the transaction records stores information identifying approvals and a chain of custody for the update inputs.

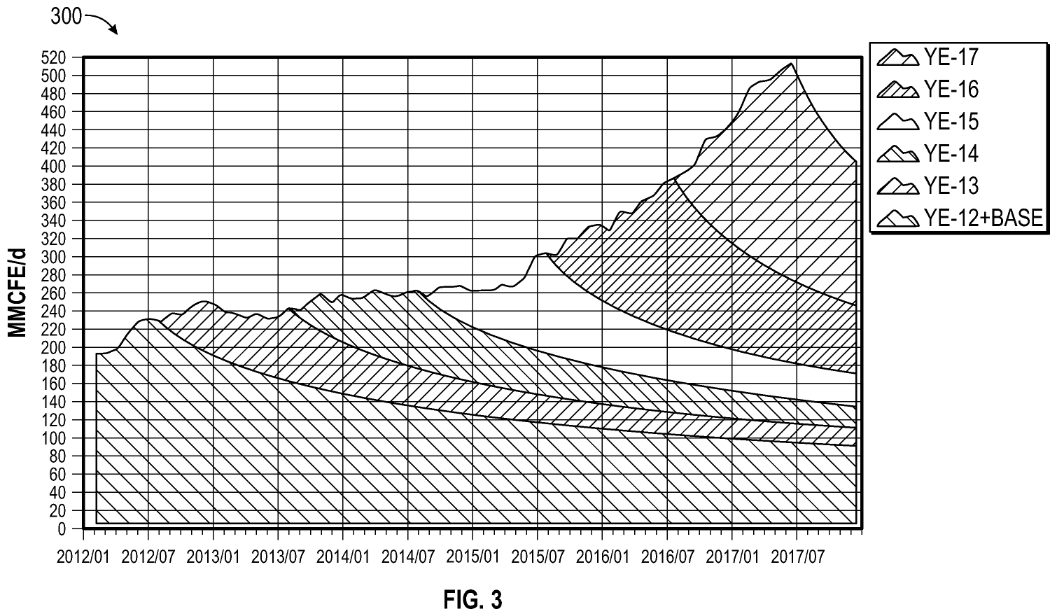

FIG. 3 illustrates an example model that may be developed and updated over time using the techniques described herein. For example, the model 300 in FIG. 3 illustrates a base production and incremental production possible over time from potential investment opportunities. The model 300 shown may be developed and updated/improved and model updates may be stored as transactions. Further, prior model versions may be stored. In some embodiments, the transactions and/or prior model versions may be studied to identity the model's development history and pinpoint any key changes that were made.

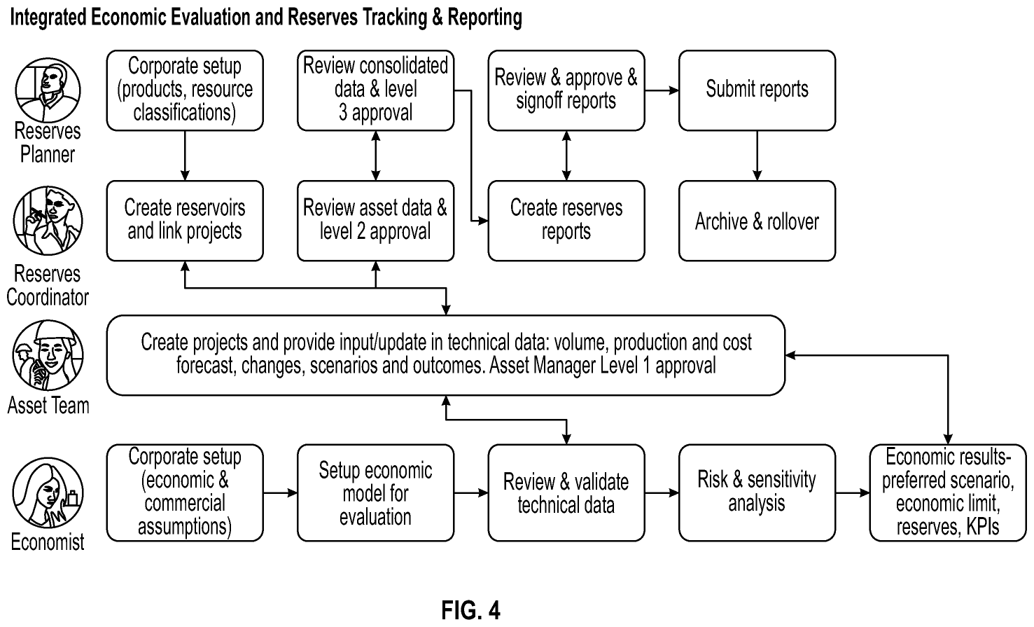

FIG. 4 illustrates an example of roles for different project team members that may use the input centralization and tracking system to collaborate and report update input incorporate progress. As shown in FIG. 4, different members with different roles may perform different tasks in conjunction with developing a model for economic evaluation and reserves tracking. The input centralization and tracking system described herein may integrate the roles of different members and contributors.

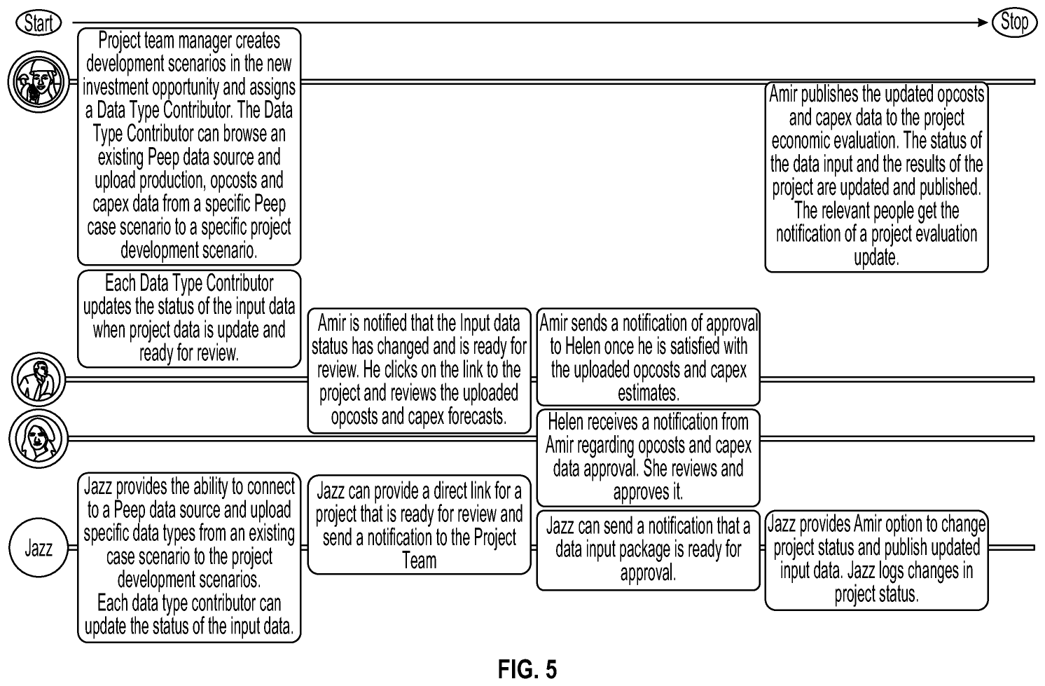

FIG. 5 illustrates an example process for integrating the roles of different contributors for incorporating model inputs to develop a model used to evaluate on an asset. As shown in FIG. 5, different team members may contribute data to update the model that an end user (e.g., economist) may use to run an evaluation. The input centralization and tracking system may track approvals and provide notifications to contributors to notify the contributors of outstanding action items and approvals to complete.

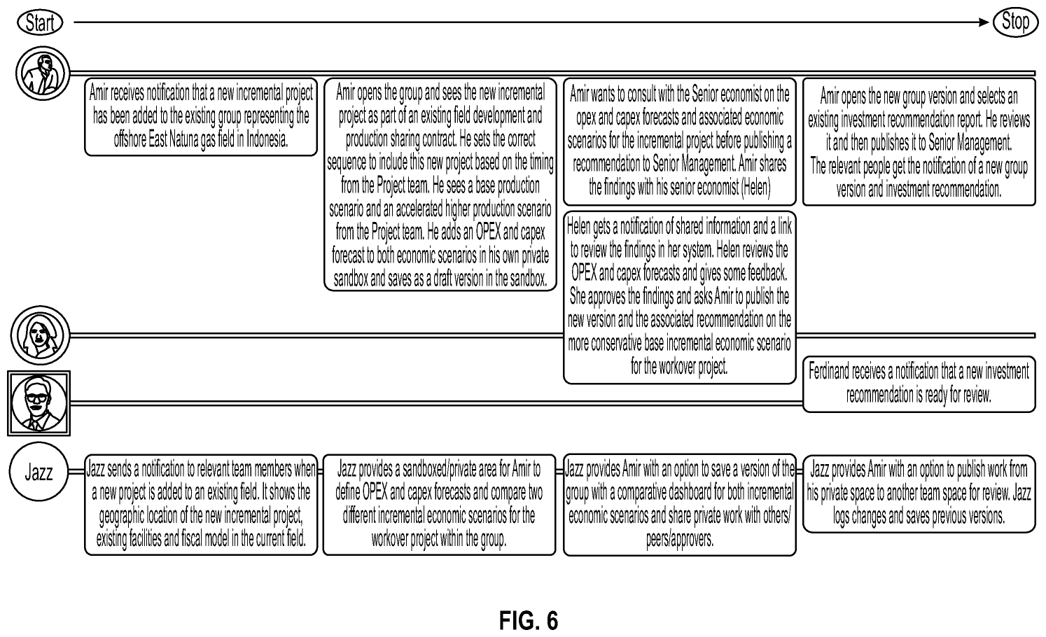

FIG. 6 illustrates another example process for integrating the roles of different contributors for incorporating model inputs to develop a model used to evaluate on an asset. As shown in the example of FIG. 6, different contributors with different roles may receive notifications regarding action items and/or approves to complete in connection with updating a model to provide an updates investment recommendation.

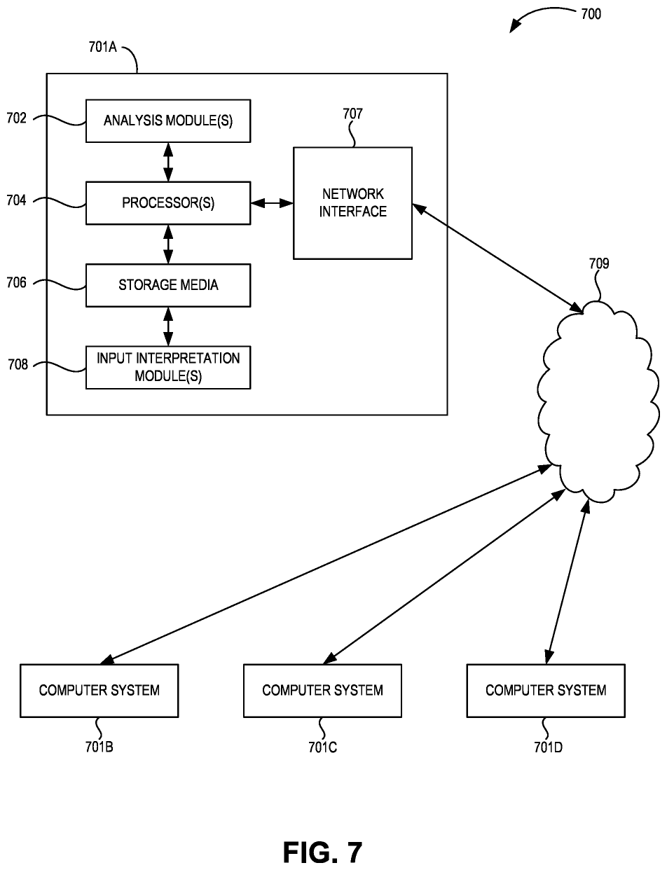

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 602 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more input centralization and tracking module(s) 708. In the example of computing system 700, computer system 701A includes the input centralization and tracking module 708. In some embodiments, a single input centralization and tracking module may be used to perform some aspects of one or more embodiments of the methods disclosed herein. In other embodiments, a plurality of input centralization and tracking modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

1. A method for centrally collecting and tracking incorporation of model update inputs for developing and updating a model, comprising:
receiving the model update inputs via a centralized system;
sending a notification to one or more contributors associated with the model notifying that the model update inputs have been received;
receiving information identifying progress of incorporation of the update inputs into the model;
generating transaction records identifying the progress and actions taken to incorporate the update inputs into the model; and
storing or outputting the transaction records.

2. The method of claim 1, wherein the model is an oil and gas-related model for evaluation of an oil and gas-related asset.

3. The method of claim 1, further comprising providing a communications platform to receive communications from the contributors regarding the progress of incorporation of the update inputs.

4. The method of claim 1, wherein the model update inputs and the information identifying the progress are received from disparate sources.

5. The method of claim 1, wherein the transaction records identify approvals and a chain of custody for the update inputs.

6. A computing system, comprising:
one or more processors; and
a memory system comprising one or more non-transitory computer-readable media storing instructions that, when executed by at least one of the one or more processors, cause the computing system to:
receive model update inputs via a centralized system;
send a notification to one or more contributors associated with a model notifying that the model update inputs have been received;
receive information identifying progress of incorporation of the update inputs into the model;
generate transaction records identifying the progress and actions taken to incorporate the update inputs into the model; and
store or output the transaction records.

7. A non-transitory computer-readable medium storing instructions that, when executed by one or more processors of a computing system, cause the computing system to:
receive model update inputs via a centralized system;
send a notification to one or more contributors associated with a model notifying that the model update inputs have been received;
receive information identifying progress of incorporation of the update inputs into the model;
generate transaction records identifying the progress and actions taken to incorporate the update inputs into the model; and
store or output the transaction records.
